(19) United States
(12) Patent Application Publication
(10) Pub. No.: US 2007/0155608 A1
(43) Pub. Date: Jul. 5, 2007

(54) HINGE AND HINGE-PRODUCING APPARATUS AND APPERTAINING METHOD FOR A CORNER EDGE OF A RECTANGULAR TUBE

(76) Inventors: Martin J. Lehmann, Fort Wayne, IN (US); Mark A. Stine, Spencerville, IN (US)

Correspondence Address: SCHIFF HARDIN, LLP;PATENT DEPARTMENT, 6600 SEARS TOWER, CHICAGO, IL, 60606-6473, US

(21) Appl. No.: 11/612,030

(22) Filed: Dec. 18, 2006

Related U.S. Application Data
(60) Provisional application No. 60/754,696, filed on Dec. 29, 2005.

(51) Int. Cl. B31C 11/02

(52) U.S. Cl. 493/287

(57) ABSTRACT

A method and apparatus for creating a hinge on a corner edge of a rectangular tube as well as a tube so produced is provided in which a roller having a line defining a diameter of the roller at approximately 45° from a line defining a planar surface of the rectangular tube, a pivot axis of the roller being oriented to permit the roller to roll longitudinally down a length of the tube. The roller comprises a v-shaped indent disposed radially around its outer periphery and a groove located at an apex of the v-shaped indent. Pressure is applied by the roller against the tube in a radial direction of the roller, thereby contacting a corner edge of the tube with the groove to stress tube material at the corner edge. A relative movement is induced between the roller and the tube in a longitudinal direction of the tube, thereby creating a hinged corner edge of the tube.

### CROSS REFERENCE TO RELATED APPLICATIONS

The present application claims the benefit of U.S. Provisional Application No. 60/754,696, filed Dec. 29, 2005, herein incorporated by reference.

### BACKGROUND

The invention relates to a hinge and hinge-producing apparatus and appertaining method for a corner edge of a rectangular tube.

Containers that are made of inexpensive materials such as paper and cardboard come in a wide variety of shapes and sizes. Elongated containers that may be used for shipping and storage frequently reflect a tradeoff between strength and cost of manufacture. One type of elongated tube that is particularly straightforward to manufacture is a tube having a circular cross-section that is typically manufactured by spirally winding a heavy paper or cardboard around a generally cylindrical mandrel. Such tubes are durable and yet relatively inexpensive to manufacture.

However, these cylindrical containers or tubes have certain disadvantages; when multiple tubes are stacked together for shipping, there is a certain amount of volume that is wasted due to the circular cross-sectional geometry of the tubes. Furthermore, such tubes do not lend themselves well to being flattened prior to use and thus can take up considerable volume when empty.

Elongated containers having a rectangular cross-section, typically made of corrugated cardboard, solve these problems in that they waste a minimal volume when stacked. Furthermore, rectangular tubes may easily be flattened prior to use, which allows for better pre-use shipment (in bulk and/or bundle packed) to end-users. This eliminates the current issue of “shipping air” found with existing round mailing/shipping tubes.

The flattening typically performed with corrugated cardboard is greatly simplified by its inherent structure. With corrugated cardboard, the outermost two sheets of relatively thin cardboard serve to sandwich a third sheet of relatively thin cardboard that is formed as a three-dimensional sine wave or s-shaped curve in one direction, and is linear in a perpendicular direction. The outermost sheets are glued or affixed to the inner sine wave sheet, which produces a structure that is much stronger than the three sheets themselves would be if simply stacked flat upon one another.

In order to flatten such a rectangular box, a folding hinge is formed in the four respective corners of the box. The hinge is formed by a crease made in a linear direction that follows a single trough or crest of the sine wave, i.e., in a direction of natural weakness of the corrugated cardboard. However, in other constructions of rectangular tubes, such as those that are wound or formed using a homogeneous material or structure, there is no natural linear weakness about which a crease can be easily formed for the hinges.

### SUMMARY

The present invention provides a method and apparatus for forming a folding hinge in corner edges of a box having at least four sides. The term “rectangular box” or “rectangular tube” will be used throughout the application, however, this term is to be understood, for the sake of expediency, to encompass not only any box or tube shape having four sides, but any shape having more than four sides such that it can be flattened and opened without additional “Joining of sides” steps.

According to an embodiment of the invention, a method is provided for creating a hinge on at least one, and possibly all, corner edge(s) of a rectangular tube, comprising: orienting a line defining a diameter of a roller at approximately 45° from a line defining a planar surface of the rectangular tube, a pivot axis of the roller being oriented to permit the roller to roll longitudinally down a length of the tube; wherein the roller comprises a v-shaped indent disposed radially around its outer periphery and a groove located at an apex of the v-shaped indent; applying pressure by the roller against the tube in a radial direction of the roller, thereby contacting a corner edge of the tube with the groove to stress tube material at the corner edge; and providing relative movement between the roller and the tube in a longitudinal direction of the tube, thereby creating a hinged corner edge of the tube.

A further method is provided for creating a hinge on a corner edge of a rectangular tube, comprising: providing relative movement between a tube corner edge stressing apparatus and the tube in a longitudinal direction of the tube, thereby creating a hinged corner edge of the tube; wherein the stressing apparatus performs an operation selected from the group consisting of: abrading, scoring, cutting, punching, drilling, or yielding, the yielding defined as a stretching of the corners from forming or folding.

The invention also comprises a rectangular tube created by the above-defined methods.

Finally, a rectangular tube hinge producing apparatus is provided, comprising: a roller that is oriented according to a line defining a diameter of a roller at approximately 45° from a line defining a planar surface of the rectangular tube, a pivot axis of the roller being oriented to permit the roller to roll longitudinally down a length of the tube; the roller comprising a v-shaped indent disposed radially around its outer periphery and a groove located at an apex of the v-shaped indent; a pressure mechanism for applying pressure by the roller against the tube in a radial direction of the roller, thereby contacting a corner edge of the tube with the groove to stress tube material at the corner edge; and a movement mechanism for providing relative movement between the roller and the tube in a longitudinal direction of the tube.

### DESCRIPTION OF THE DRAWINGS

An embodiment of the invention is explained below with reference to the following Figures.

FIG. 1A is an isometric pictorial illustration of a spiral-wound rectangular tube having a corner edge hinge according to an embodiment of the invention;

FIG. 1B is an end-view showing a tube in a collapsing configuration;

FIG. 1C is a pictorial illustration of an embodiment of the hinge;

FIG. 1D is an end-view pictorial illustration of a collapsed stack of tubes;

FIG. 2A is an end view of the tube as the corners are being shaped by rollers;

FIG. 2B is an exploded side view of the tube and rollers shown in FIG. 2A;

FIG. 3A is an isometric view of a collapsed tube having an integrated end support portion;

FIG. 3B is an isometric view of an uncollapsed tube with the end support portion unfastened; and

FIG. 3C is an isometric view of an uncollapsed tube with the end support portion fastened.

### DETAILED DESCRIPTION OF THE PREFERRED EMBODIMENTS

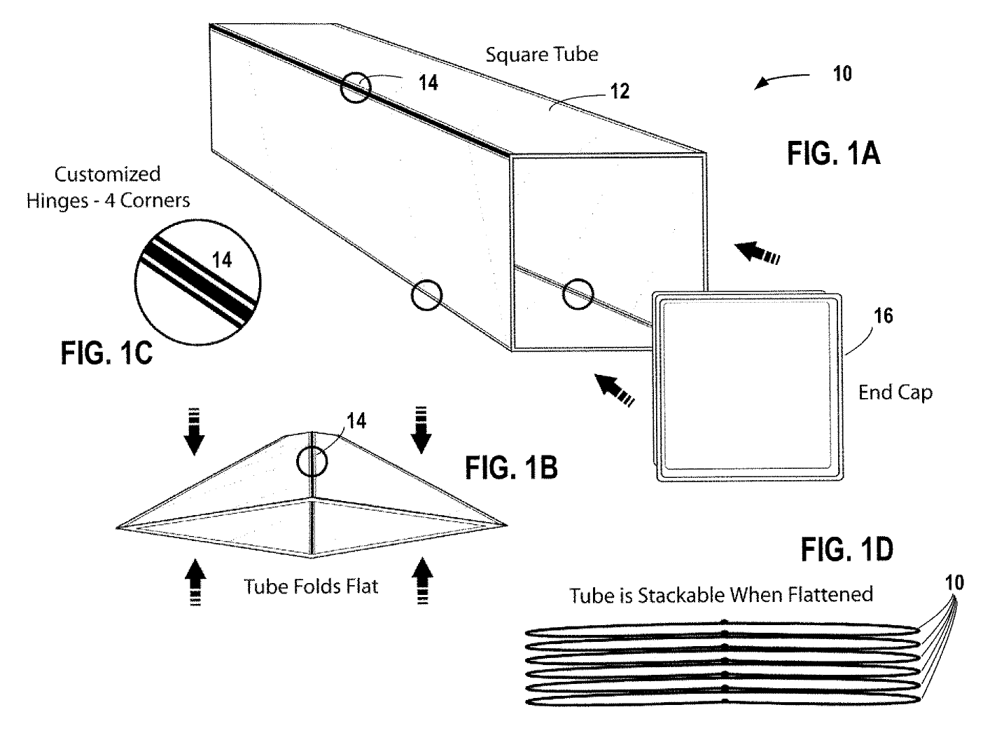

FIG. 1A illustrates an embodiment of a corner hinge 14 of a rectangular tube 10 comprising planar sides 12 that intersect at the corner hinges 14. Although the tube is illustrated as being rectangular and having four sides, nothing precludes the use of the hinge 14 on tube constructions having fewer or more sides.

The tube 10 may also comprise an end cap 16 which may be placed on both ends of the tube 10 for strength and stability. FIG. 1B illustrates a compression of the tube 10 into a flat configuration. As can be seen, the hinges 14 (as illustrated in FIG. 1C) for one pair of opposite corners exhibits a wider (more obtuse) angle as the tube 10 is flattened, whereas the other pair of opposite corners exhibits a narrower (more acute) angle as the tube 10 is flattened. The flexible hinge 14 permits an angle between adjacent sides from nearly 0° to 180° without destroying or damaging the corner in any substantial manner, permitting numerous flexes of the corner, i.e., numerous expanding and flattening cycles.

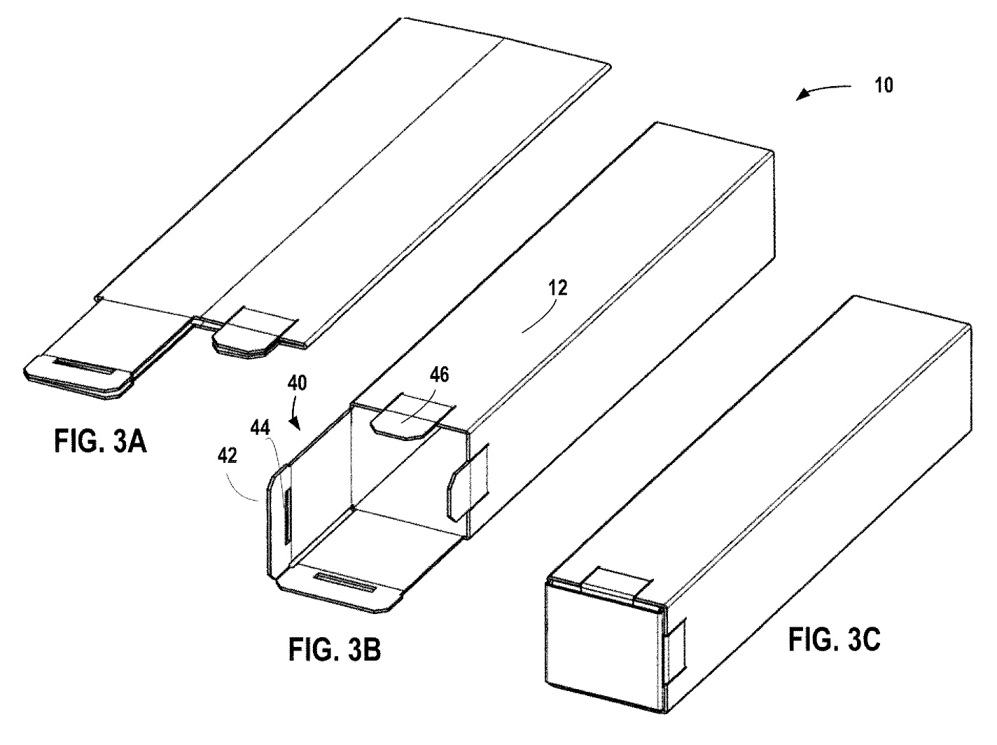

In an alternate embodiment, illustrated in FIGS. 3A-C, an end support structure 40 can be formed out of the tube 10 that can be utilized in place of the end cap 16 to support the tube in its open or uncollapsed state. FIG. 3A shows this embodiment in a collapsed state and illustrates the exemplary cuts and folds that could be utilized to form a support structure. FIG. 3B illustrates this embodiment in an open state, where the end support structure 40 is unfastened. Finally, FIG. 3C illustrates this embodiment in an open state, where the end support structure 40 is fastened to provide support.

As illustrated in FIG. 3B, the end support structure 40 comprises end tabs 46 that project from two adjacent sides 12 of the box 10. The tabs 46 have cut lines that extend into the box sides 12, and a fold located at a position where the remaining side 12 that is not a part of the tab 46 ends. The end support structure 40 further comprises end flaps 42 that project from the remaining two adjacent sides 12 of the box 10. Each of the end flaps 42 comprise a slot 44 into which the tabs 46 may be inserted once the end flaps 42 are folded. A fold line of the end flaps 42 permits a portion of the end flaps 42 to be inserted into the tube 10 when the end flaps 42 themselves are folded to cover a bottom portion of the tube 10. Once the tabs 46 are inserted into the slots 44, a rigid support structure is formed to hold the tube in its open or uncollapsed configuration without the need for a supporting end cap 16.

When empty tubes 10 are empty and flattened, they may be stacked, as illustrated in FIG. 1D to conserve space when shipping and storing.

As noted above, with corrugated cardboard, the corner edges are formed along inherent weaknesses in the corrugated structure. However, when the tube lacks such an inherent structural weakness, a different methodology must be employed for forming the flexible hinges 14. Such tubes may be those produced by, e.g., a spiral winding process in which multiple layers of cardboard are wound to create the tube structure. The invention is not limited to cardboard, however, and can be any rigid or semi-rigid material that provides some level of support when wound in the above-described manner—this could be any pulp-based, plastic, composite, metallic, fiber-based, or other material. In this construction, there is no inherent weakness along any particular axis of the tube. Similarly, other constructions are conceivable in which the tube is formed or extruded from a relatively homogeneous material having no inherent structural weaknesses.

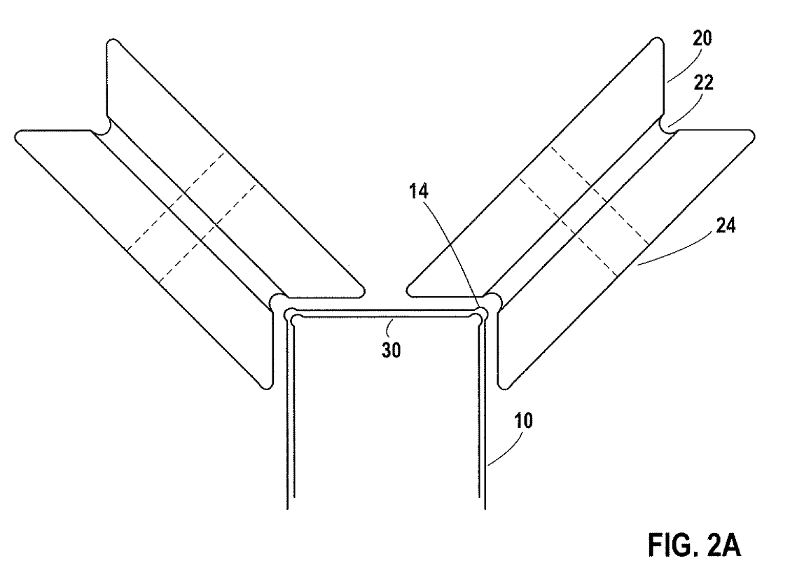

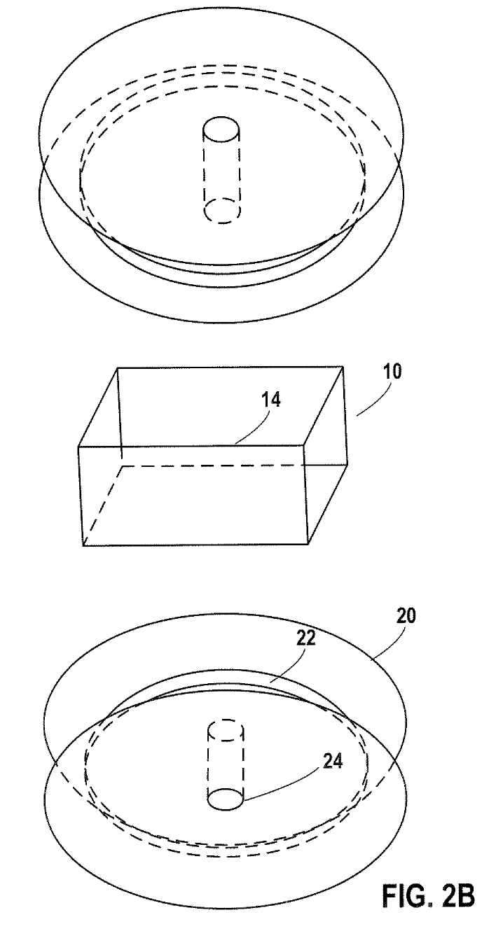

In order to form the flexible hinges 14 for such compositions, an embodiment of the invention is illustrated in FIGS. 2A, B. FIG. 2A is an end view showing the tube 10 having its corners formed as the flexible hinges 14 by rollers 20. The rollers 20 are mounted (mounting not shown) on axels that extent through holes 24 in the rollers 20 and permit them to rotate about the axels. As can be seen in FIG. 2A, the rollers 20 are mounted at approximately 45° to the sides of the box. The rollers 20 in the cross sectional plane illustrated in FIG. 2A that is parallel to the axels have a v-shaped indent extending in a radial direction, and at the innermost portion of the v-shaped indent is a groove 22 that serves to form the flexible hinge portion 14 of the box 10. FIG. 2B is simply a semi-exploded side view of the configuration shown in FIG. 2A.

The hinge portion 14 is created by applying pressure on the box 10 corners with the groove 22, ideally in a direction that is perpendicular to the axis of rotation. With the box 10 in an open position, as illustrated in FIG. 2A, it is possible to crush the box 10 with the rollers 20. Therefore, it is preferable to have an inner support 30 for the box 10 that prevents it from becoming crushed when pressure is applied by the rollers. The portion of the box 10 in contact with the groove 22 is stressed, thinned, and shaped, which thereby forms the basic construction of the hinge. It should be noted that although a basic groove 22 structure that approximates a semicircle in cross section is shown, it is possible to utilize any number of shapes that would optimize a hinge functionality, such as multiple half circles, squared shapes, V-shapes, multiple squares and V's, etc. Also, it may be possible to invert the shapes on the corners, providing that the inner support mandrel take on the indentation as apposed to the indentation inherent in the roller system(s). Therefore the roller system would provide an inverted grove structure. Furthermore, it may be possible that the crushing of the material could be accomplished with flat rollers, essentially not providing or taking on a shape at all, as described above.

In an embodiment of the invention, it is possible to moisten the corners of the box 10 prior to applying pressure with the rollers 20 so that the hinge portion 14 is more easily formed by the roller. In the event that plastics or other types of heat-sensitive materials are used, it is also possible to heat the corners immediately prior to contact with the groove 22 to make the hinges 14 more easily formed. Moistening the corners could also include a solvent or chemical treatment to the corners that would either prevent the adhesive from bonding or dissolve the cured adhesive. Adding water could be considered another chemical to process the corners and make them more flexible.

It should further be noted that although the rollers 22 described above utilize pressure to crush the material from which the box 10 is made, it is also possible to use cutters (either longitudinal or cross-cut) within the groove 22 region or on the interior support 30 that would serve to score the box corners or perforators/punches that would weaken the corner by introducing holes. Additionally, reduction of the wall thickness at the desired hinge location in a linear direction along a primary axis of the box could be performed by abrading, scoring, cutting, punching, drilling, or yielding (stretching the corners from forming or folding). These processes could be performed continuously along the length or intermittently, similar to a perforation operation.

One of the primary advantages to this method for forming hinges is that it is ideally suited for continuously formed tubes 10, such as those made by spiral winding or an extrusion process. Advantageously, in this application, the flexible hinges 14 can be formed before any adhesives used are fully dried or any materials used are fully set, thereby aiding in the formation of the hinges 14 while the material is in a more pliable state.

Additionally, in order to flatten the tubes, one can simply take any square tube and run the tube through a two-roller system similar to an old-fashioned clothes ringer system in which two large smooth rollers simply compress the entire tube after it has been formed in the above-described manner. Alternately, any mechanism can be utilized to flatten the tubes after they have been formed, such as running the tubes through a narrowing chute having an entrance end sized to accept the tube in its un-flattened form and an exit end sized to flatten the tube, wherein the narrowing portion of the chute has sides that press against the tube to flatten it as it is being fed through the chute.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The present invention may be described in terms of functional block components and various processing steps. Such functional blocks may be realized by any number of hardware components configured to perform the specified functions. The particular implementations shown and described herein are illustrative examples of the invention and are not intended to otherwise limit the scope of the invention in any way. For the sake of brevity, conventional structural and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

TABLE OF REFERENCE CHARACTERS

| | |
|---|---|
| 10 | rectangular tube |
| 12 | planar sides |
| 14 | flexible hinge |
| 20 | roller |
| 22 | roller groove |
| 24 | roller axel hole |
| 30 | inner support |
| 40 | end support structure |
| 42 | end flap |
| 44 | end flap slot |
| 46 | end tab |

What is claimed is:

1. A method for creating a hinge on a corner edge of a rectangular tube, comprising:
orienting a line defining a diameter of a roller at approximately 45° from a line defining a planar surface of the rectangular tube, a pivot axis of the roller being oriented to permit the roller to roll longitudinally down a length of the tube;
wherein the roller comprises a v-shaped indent disposed radially around its outer periphery and a groove located at an apex of the v-shaped indent;
applying pressure by the roller against the tube in a radial direction of the roller, thereby contacting a corner edge of the tube with the groove to stress tube material at the corner edge; and
providing relative movement between the roller and the tube in a longitudinal direction of the tube, thereby creating a hinged corner edge of the tube.

2. The method according to claim 1, further comprising:
providing an inner support inside the tube against which an inner portion of the tube is braced when applying the pressure, thereby preventing the tube from being crushed.

3. The method according to claim 1, wherein the groove shape has a semi-circular cross-sectional shape.

4. The method according to claim 1, wherein the groove is concave with respect to the v-shaped indent.

5. The method according to claim 1, wherein the groove is convex with respect to the v-shaped indent.

6. The method according to claim 1, further comprising:
moistening the corner edges of the tube prior to the applying of pressure.

7. The method according to claim 6, wherein the moistening comprises applying water.

8. The method according to claim 6, wherein the moistening comprises applying a non-water chemical treatment.

9. The method according to claim 1, further comprising:
heating the corner edges of the tube prior to the applying of pressure.

10. The method according to claim 1, further comprising:
cutting the corner edges of the tube while applying pressure with a cutter located in the groove area.

11. The method according to claim 2, further comprising:
cutting the corner edges of the tube while applying pressure with a cutter located on the inner support.

12. The method according to claim 1, further comprising:
perforating the corner edges of the tube while applying pressure with a perforator located in the groove area.

13. The method according to claim 2, further comprising:
perforating the corner edges of the tube while applying pressure with a perforator located on the inner support.

14. The method according to claim 1, wherein the applying of pressure occurs prior to a setting of materials used to create the tube.

15. The method according to claim 1, further comprising, during the providing of relative movement:
flattening the tubes after the hinged corner edge of the tube has been produced.

16. The method according to claim 15, wherein the flattening is performed by a two-roller system.

17. The method according to claim 15, wherein the flattening is performed by a narrowing chute.

18. The method according to claim 1, further comprising:
removing portions from at least one end of the tube in order to form a locking support mechanism formed from the tube itself.

19. The method according to claim 18, wherein removing portions comprises:
forming a tab in two adjacent sides of the tube; and
forming an end flap in remaining sides of the tube and forming slots within each of the end flaps that are adapted to accept the tabs when the end flap is folded in a manner that supports the tube in an open configuration.

20. A method for creating a hinge on a corner edge of a rectangular tube comprising:
providing relative movement between a tube corner edge stressing apparatus and the tube in a longitudinal direction of the tube, thereby creating a hinged corner edge of the tube;
wherein the stressing apparatus performs an operation selected from the group consisting of: abrading, scoring, cutting, punching, drilling, or yielding, the yielding defined as a stretching of the corners from forming or folding.

21. A rectangular tube having a hinge on its corner that is produced by a method comprising:
orienting a line defining a diameter of a roller at approximately 45° from a line defining a planar surface of the rectangular tube, a pivot axis of the roller being oriented to permit the roller to roll longitudinally down a length of the tube;
wherein the roller comprises a v-shaped indent disposed radially around its outer periphery and a groove located at an apex of the v-shaped indent;
applying pressure by the roller against the tube in a radial direction of the roller, thereby contacting a corner edge of the tube with the groove to stress tube material at the corner edge; and
providing relative movement between the roller and the tube in a longitudinal direction of the tube, thereby creating a hinged corner edge of the tube.

22. A rectangular tube hinge producing apparatus, comprising:
a roller that is oriented according to a line defining a diameter of a roller at approximately 45° from a line defining a planar surface of the rectangular tube, a pivot axis of the roller being oriented to permit the roller to roll longitudinally length of the tube;
the roller comprising v-shaped indent disposed radially around its outer periphery and a groove located at an apex of the v-shaped indent;
a pressure mechanism for applying pressure by the roller against the tube in a radial direction of the roller, thereby contacting a corner edge of the tube with the groove to stress tube material at the corner edge; and
a movement mechanism for providing relative movement between the roller and the tube in a longitudinal direction of the tube.
